(19) United States
(12) Patent Application Publication
(10) Pub. No.: US 2010/0250067 A1
(43) Pub. Date: Sep. 30, 2010

(54) VEHICULAR STEERING CONTROL APPARATUS AND METHOD

(75) Inventors: Tatsuo Matsumura, Atsugi-shi (JP); Mitsuo Sasaki, Hadano-shi (JP); Toru Takahashi, Hiratsuka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Automotive Systems, Ltd.

(21) Appl. No.: 12/729,808

(22) Filed: Mar. 23, 2010

(30) Foreign Application Priority Data
Mar. 24, 2009 (JP) 2009-071555

(51) Int. Cl. G06F 19/00; H02P 6/10; H02P 21/14; B62D 6/00

(52) U.S. Cl. 701/41; 318/400.23; 318/400.02

(57) ABSTRACT

In vehicular steering control apparatus and method, a carrier frequency of a PWM control signal to drive an electric motor on a basis of the manipulated variable of the electric motor is controlled and the carrier frequency is set to at least two predetermined set frequencies in accordance with at least one of a driving state of the electric motor and a traveling state of the vehicle, one of the predetermined set frequencies being set to reduce noises in the inverter and the other of the predetermined set frequencies being set to reduce a switching loss in the inverter. For example, the carrier frequency is set to be lowered to the other of the predetermined set frequencies in a case where a rotational speed of the electric motor is driven in a rotational speed region (A2) higher than that in a constant torque region (A1).

### BACKGROUND OF THE INVENTION

(1) Field of the Invention

The present invention relates to vehicular steering control apparatus and method which drivingly control an electric motor to provide a steering force for a steering mechanism which steers vehicular steerable wheels.

(2) Description of Related Art

In a case where an electric motor is driven by means of a PWM (Pulse Width Modulation) control of an inverter, noises are generated due to switching operations of the inverter in accordance with a carrier frequency of a PWM control signal. In order to reduce the noises in the inverter, it is effective to set a carrier frequency at a non-audible frequency higher than an audible frequency. However, such a problem that, if the carrier frequency of the inverter is increased, a frequency of the switching operations in the inverter is increased and a switching loss is, thus, increased. As described hereinabove, since a trade-off relationship is established between a reduction in the noises and a reduction in the switching loss, a mode selection switch is provided to select which a greater importance is placed on a low loss or a silence, for example, in a technique described in a Japanese Patent Application Publication No. 2008-22671 published on Jan. 31, 2008.

The technique described in the above-described Japanese Patent Application Publication is such that a drive motor to drive driving wheels of a hybrid vehicle is drivingly controlled through the PWM control of the inverter and a traveling mode of the hybrid vehicle is selectable from a silence importance mode in which a greater importance is placed on a silence and a fuel economy importance mode in which the greater importance is placed on a fuel economy. In other words, in a case where a vehicle driver selects the silence importance mode through the mode selection switch, the carrier frequency is set to be increased to reduce the noises of the inverter and, in a case where the fuel economy importance mode is selected through the mode selection switch, the carrier frequency is set to be lowered to reduce the switching loss in the inverter.

### SUMMARY OF THE INVENTION

However, in the technique described in the above-described Japanese Patent Application Publication, the vehicle driver selects the traveling mode. Hence, if this technique were merely applied to a steering control apparatus, the carrier frequency could not appropriately be set in accordance with a traveling state of the vehicle. In such a case of an avoidance traveling of a collision of an object or of a low-speed traveling where a high output is required for the electric motor which generates a steering force, there is a possibility that this requirement cannot be satisfied due to the switching loss in the inverter.

It is, therefore, an object of the present invention to provide vehicular steering control apparatus and method which are capable of reducing the switching loss of the inverter when a high output of the electric motor generating the steering force is required.

According to one aspect of the present invention, there is provided a vehicular steering control apparatus, comprising: a steering mechanism configured to steer steerable wheels of a vehicle according to a steering force; an electric motor configured to be drivingly controlled to provide the steering force for the steering mechanism; a steering quantity calculation section configured to calculate a manipulated variable of the electric motor; a PWM control section configured to generate a PWM control signal to drive the electric motor on a basis of the manipulated variable of the electric motor; an inverter configured to supply an electric power to the electric motor according to switching operations thereof based on the PWM control signal; and a carrier frequency control section configured to control a carrier frequency of the PWM control signal, wherein the carrier frequency control section is configured to set the carrier frequency to at least two predetermined set frequencies in accordance with at least one of a driving state of the electric motor and a traveling state of the vehicle, one of the predetermined set frequencies being set to reduce noises in the inverter and the other of the predetermined set frequencies being set to reduce a switching loss in the inverter.

According to another aspect of the present invention, there is provided a vehicular steering control method comprising: providing a steering mechanism configured to steer steerable wheels of a vehicle according to a steering force; providing an electric motor configured to be drivingly controlled to provide the steering force for the steering mechanism; calculating a manipulated variable of the electric motor; generating a PWM control signal to drive the electric motor on a basis of the manipulated variable of the electric motor; providing an inverter for supplying an electric power to the electric motor according to switching operations thereof based on the PWM control signal; and controlling a carrier frequency of the PWM control signal,

wherein, during the control of the carrier frequency, the carrier frequency is set to at least two predetermined set frequencies in accordance with at least one of a driving state of the electric motor and a traveling state of the vehicle, one of the predetermined set frequencies being set to reduce noises in the inverter and the other of the predetermined set frequencies being set to reduce a switching loss in the inverter.

### BRIEF DESCRIPTION OF THE DRAWINGS

FIG. 1 is a configuration view representing an electric power steering apparatus to which a vehicular steering control apparatus as a first preferred embodiment according to the present invention is applicable.

FIG. 2 is a configuration view representing a detailed functional diagram of a control unit shown in FIG. 1.

FIG. 3 is a detailed view of an inverter shown in FIG. 1.

FIGS. 4(A) and 4(B) are graphs representing a relationship between a rotational speed ω and a torque (N-T characteristic) in the electric motor shown in FIG. 1 and representing a carrier frequency map in the first embodiment shown in FIG. 1.

FIG. 5 is an integrally graph representing a torque and a rotational speed ω (N-T characteristic) in the first embodiment and the N-T characteristic of the electric motor in comparative examples.

FIG. 6 is a detailed functional block diagram of the control unit as a second preferred embodiment according to the present invention.

FIG. 7 is a graph representing a relationship between a primary current Ib and the N-T characteristic of the electric motor in the case of the case of the second embodiment.

FIG. 8 is a graph representing a carrier frequency of the electric motor and the primary current in the case of the second embodiment.

FIG. 9 is a detailed functional block diagram in the control unit as a third preferred embodiment of the vehicular steering control apparatus according to the present invention.

FIG. 10 is a graph representing a relationship among an input voltage, a torque, and rotational speed ω in the electric motor in a case of the third embodiment shown in FIG. 9.

FIG. 11 is a graph representing a relationship between a carrier frequency and an input voltage Vi in a case of the third embodiment shown in FIG. 9.

FIG. 12 is a detailed functional block diagram of the control unit as a fourth preferred embodiment according to the present invention.

FIG. 13 is a graph representing a relationship between rotational speed of the electric motor and an integration value of an q-axis current deviation in a case of the fourth embodiment shown in FIG. 12.

FIG. 14 is a graph representing a relationship between the carrier frequency and an integration value ∫ΔIqdt of q-axis current deviation in the case of the fourth embodiment shown in FIG. 12.

FIG. 15 is a detailed block diagram of the control unit in a case of a fifth embodiment according to the present invention.

FIG. 16 is a graph representing a relationship between a rotational speed ω of electric motor and a d-axis target current of the electric motor.

FIG. 17 is a graph representing a relationship between a carrier frequency and an absolute value of the d-axis target current |Id*|, respectively.

FIG. 18 is a detailed functional block diagram of the control unit in a case of a sixth preferred embodiment according to the present invention.

FIG. 19 is a graph representing a relationship between carrier frequency and a modulation rate M in a case of the sixth embodiment shown in FIG. 18.

FIG. 20 is a detailed functional block diagram in the control unit in a case of a seventh preferred embodiment according to the present invention.

FIG. 21 is a graph representing a relationship between the carrier frequency and a traveling speed v in a case of the seventh embodiment shown in FIG. 20.

FIG. 22 is a configuration view of the functional block diagram of the control unit in a case of an eighth preferred embodiment according to the present invention.

FIG. 23 is a graph representing a relationship between the carrier frequency and traveling speed v in the case of the eighth embodiment.

FIG. 24 is a detailed functional block diagram in the control unit in a case of a ninth preferred embodiment according to the present invention.

FIG. 25 is a graph representing a relationship between the carrier frequency and a steering speed ωs in a case of the ninth embodiment.

FIG. 26 is a detailed functional block diagram in the control unit in a case of a tenth preferred embodiment according to the present invention.

FIG. 27 is a graph representing a relationship between the carrier frequency and a steering speed ωs.

FIG. 28 is a detailed functional block diagram in the control unit as an eleventh preferred embodiment according to the present invention.

FIGS. 29 (A) and 29(B) are graphs representing relationships between the carrier frequency and the traveling speed v of the vehicle and between the carrier speed and steering speed ωs in the case of the eleventh embodiment shown in FIG. 28.

### DETAILED DESCRIPTION OF THE INVENTION

Reference will, hereinafter, be made to the drawings in order to facilitate a better understanding of the present invention.

### First Embodiment

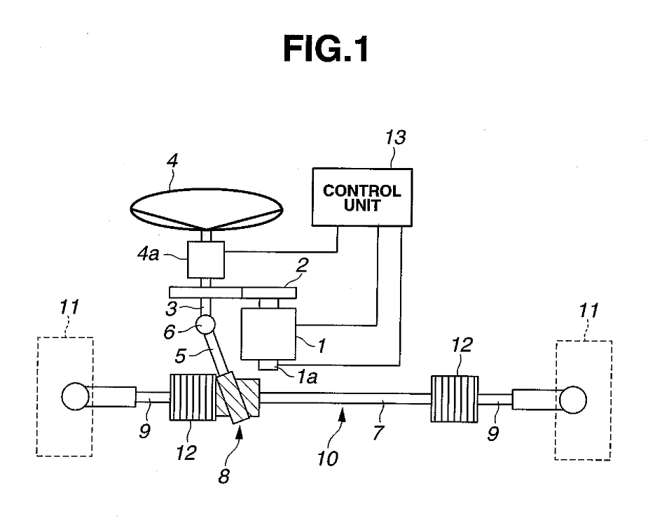

FIG. 1 shows a configuration view of an electric power steering apparatus to which a vehicular steering control apparatus according to the present invention is applicable, as a first preferred embodiment according to the present invention.

The electric power steering apparatus shown in FIG. 1 is, so-called, of an assistance torque type in which an assistance torque generated by an electric motor 1 driven by an electric power of a three-phase alternating current transmitted to a steering shaft 3 via a speed reducer 2. A steering wheel 4 which is rotated as a unit with steering shaft 3 is provided on one end of steering shaft 3. On the other hand, a pinion shaft 5 is linked with the other end of steering shaft 3 via a universal joint 6.

Pinion shaft 5 constitutes a steering gear 8 of, so-called, rack-and-pinion type together with a rack bar 7. In other words, when steering wheel 4 is rotated together with pinion shaft 5, a rotary motion of pinion shaft 5 is transformed into a linear motion of rack bar 7 and left and right steerable wheels 11, 11 which are front wheels of an automotive vehicle are steered via a link mechanism 10 in a form of a steering mechanism constituted by tie rods 9, 9 connected to respective left and right ends of rack bar 7. In FIG. 1, 12, 12 denote dust boots and left and right ends of rack bar 7 and left and right tie rods 9, 9 are respectively interconnected together through universal joints (not shown) provided within dust boots 12, 12.

A manually operable steering torque for a vehicle driver to rotationally operate steering wheel 4 is detected by means of a torque sensor 4a attached around steering shaft 3. A control unit 13 drives electric motor 1 on a basis of an output of a resolver 1a built in electric motor 1 in addition to an output of torque sensor 4a. Thus, electric motor 1 generates an assistance torque which secondarily assists the manually operable steering torque and this assistance torque is transmitted as a steering force to a link mechanism 10 via steering shaft 3 and steering gear 8.

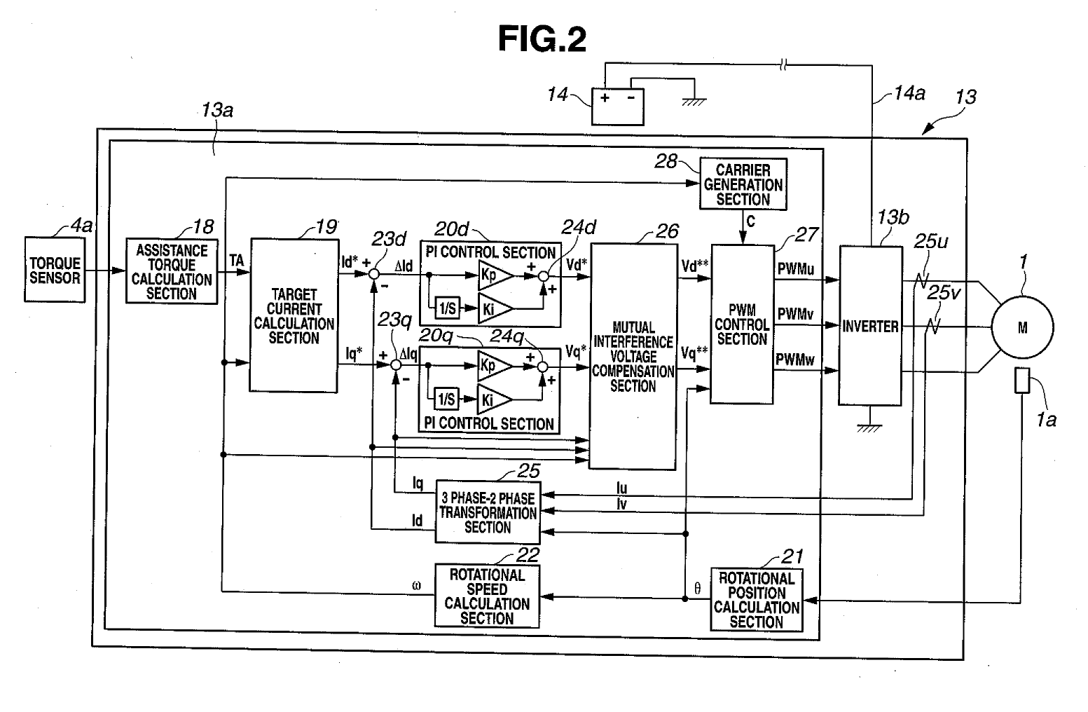

FIG. 2 shows a detailed functional block diagram of control unit 13 shown in FIG. 1. As shown in FIG. 2, control unit 13 includes: a main control section 13a configured to generate PWM control signals of PWMu, PWMv, and PWMw to drive electric motor 1 on a basis of the outputs of torque sensor 12 and resolver 1a; and an inverter 13b which supplies an electric power from a battery 14 as a power supply to electric motor 1 according to the switching operations based on PWM control signals PWMu, PWMv, and PWMw. It should be noted that a battery 14 is connected to inverter 13b via a cable 14a.

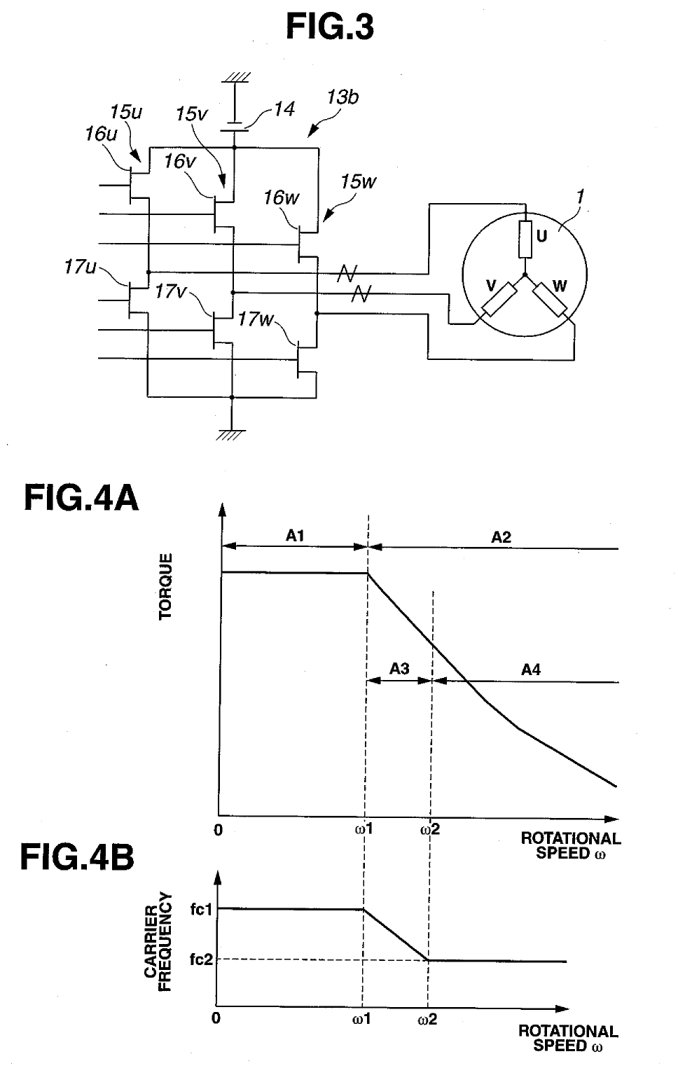

Inverter 13b includes an U-phase arm 15u, a V-phase arm 15v, and a W-phase arm 15w, as appreciated from FIG. 3. Each arm 15u, 15v, and 15w is such that high-side FETs (Field Effect Transistors) 16u, 16v, and 16w are serially connected to low-side FETs 17u, 17v, and 17w, these FETs being switching elements. Ends of respective arms 15u, 15v, and 15w located at high-side FETs 16u, 16v, and 16w are connected to battery 14. On the other hand, the other ends of respective arms 15u, 15v, and 15w located at low-side FETs 17u, 17v, and 17w are grounded. Middle points between high-side FETs 16u, 16v, 16w and low-side FETs 17u, 17v, and 17w are respectively connected to coils of respective phases U, V, and W of electric motor 1. Then, as well known in the art, inverter 13b provides the electric power of three-phase alternating current for electric motor 1 according to the switching operation of respective FETs.

Next, a specific construction of main control section 13a will be explained on a basis of FIG. 2. As shown in FIG. 2, main control section 13a controls electric motor 1 through a vector control using a rotational reference frame including a q-axis which is a rotation direction of electric motor 1 and a d-axis which is orthogonal to its q-axis.

Specifically, an assistance torque calculation section 18 of main control section 13a calculates a target assistance torque TA on a basis of the output of torque sensor 4a and outputs a target assistance torque TA to a target current calculation section 19.

Target current calculation section 19 calculates target currents Id*, Iq* of d-axis and q-axis on a basis of rotational speed ω of electric motor, namely, rotational speed ω of a rotor (not shown) in electric motor 1 and outputs target currents Id*, Iq* to d-axis and q-axis first calculation circuits 23d, 23q which are current deviation calculation sections. In details, a rotational speed ω is calculated on a basis of an output of resolver 1a. In details, a rotational position calculation section 21 calculates a rotational position θ of the rotor (not shown) in electric motor 1 on a basis of the output of resolver 1a and a rotational speed calculation (determination) section 22 calculates revolution speed ω by differentiating rotational position θ.

It should, herein, be noted that, as is well known, an q-axis target current Iq* is a current in a q-axis component in the vector control in which the rotational reference frame is used and serves to control a magnitude of the torque generated in electric motor 15 and a d-axis target current Id* is a current in a d-axis is component in the vector control in which the rotational reference frame is used and serves to weaken a field of electric motor 1. In other words, target current calculation section 19 performs, so-called, a field weakening control to weaken the field of d-axis target current Id* by increasing d-axis target current Id* along with an increase in rotational speed ω of electric motor 1.

Then, a d-axis first calculation section 23d calculates a d-axis current deviation ΔId by subtracting a d-axis actual current Id flowing into electric motor 1 from d-axis target current Id* and outputs this d-axis current deviation ΔId to a d-axis PI control section 20d which is a manipulated variable calculation section. On the other hand, q-axis first calculation section 23q calculates a q-axis current deviation ΔIq by subtracting a q-axis actual current Id flowing into electric motor 1 from q-axis target current Iq* and outputs this q-axis current deviation ΔIq to a q-axis PI control section 20q which is the manipulated variable calculation section. These d-axis and q-axis actual currents Id, Iq are a conversion of three-phase excitation currents Iu, Iv, and Iw supplied to electric motor 1 into a three-phase-to-two-phase transformation section 25.

In details, U-phase and V-phase excitation currents Iu, Iv from among three-phase excitation currents Iu, Iv, and Iw are detected by actual current sensors 25u, 25v. On the other hand, excitation current Iw of W phase is calculated in three-phase-to-two-phase transformation section 25 on a basis of U-phase and V-phase excitation currents Iu, Iv.

Both d-axis and q-axis PI control sections 20d, 20q calculate d-axis and d-axis target supply voltages Vd*, Vq* through, so-called, PI controls (proportional-and-integral control). In details, d-axis PI control section 20d calculates a d-axis target supply voltage Vd* through a proportional-integral calculation in which a proportional term of d-axis current deviation ΔId multiplied with a proportional gain Kp is added to an integration value of d-axis current deviation ΔId multiplied by integration gain Ki at a d-axis second calculation section 24d. On the other hand, q-axis PI control section 20q calculates q-axis target supply voltage Vd* through the proportional-integral calculation in which the proportional term of q-axis current deviation ΔIq multiplied with proportional gain Kp is added to the integration value of q-axis current deviation ΔIq multiplied by integration gain Kp at a q-axis second calculation section 24q.

Then, d-axis and q-axis target supply voltages Vd*, Vq* are corrected to corrected target supply voltages Vd** and Vq** by means of a mutual interference voltage compensation section 26 to prevent a mutual interference between d-axis current and q-axis current. Corrected target supply voltages Vd** and Vq** are is outputted to PWM control section. Specifically, mutual interference voltage compensation section 26 calculates compensation voltages in the d-axis and in the q-axis on a basis of actual currents Id, Iq and rotational speed ω of electric motor 1 and adds these compensation voltages in the d-axis and q-axis to d-axis and q-axis target supply voltages Vd*, Vq* respectively to obtain d-axis and q-axis corrected target supply voltages Vd**, Vq**.

PWM control section 27 converts d-axis and q-axis corrected target supply voltages Vd**, Vq** into three-phase target supply voltages by a comparison of a triangular wave carrier signal C which is generated by carrier generating section 28 as will be described later with a three-phase target supply voltage to generate and output pulsate three-phase PWM controls signals PWMu, PWMv, and PWMv signals to inverter 13b. Respective FETs of inverter 13b perform switching operations by means of PWM control signals PWMu, PWMv, and PWMw so that the electric power is supplied to electric motor 1. Electric motor 1 generates an assistance torque in accordance with a target assistance torque TA.

The generation of carrier signal C by means of carrier generating section 28 which is a carrier frequency control section will be explained below on a basis of FIGS. 4A and 4B. It should be noted that FIG. 4(A) shows a graph indicating an N-T characteristic (rotational speed-torque characteristic) of electric motor 1. FIG. 4(B) shows a carrier frequency map to set a carrier frequency of carrier signal C. As shown in FIG. 4(A), electric motor 1 provides a maximum torque generable in a constant torque region A1 which is a low-speed region equal to or below a base (rotational) speed ω1. In addition, in a rotational speed region A2 in which rotational speed ω of electric motor 1 is in excess of base (rotational) speed ω1, the torque generable along with the increase in rotational speed ω is decreased. In this rotational speed region A2, electric motor 1 is generable a maximum output. It is, naturally, that, since electric motor 1 is linked to steering shaft 3 via speed reducer 2, rotational speed ω of electric motor 1 is set to be proportional to the rotational speed of a steering speed, viz., the rotational speed of steering wheel 4. In addition, in this embodiment, the speed reduction ratio of speed reducer 2 and a characteristic of electric motor 1 are selected in order for a region of steering speed from 200 deg/sec to 400 deg/sec which demands a high output for electric motor 1 to correspond to rotational speed region A2 with a conversion of the steering speed to the rotational speed of electric motor 1. A reason that a high output is required for electric motor 1 when the steering speed ranges from 200 deg/sec to 400 deg/sec is that the steering speed whose ranges are described above corresponds to the steering speed during a time at which the object collision avoidance steering operation is performed.

Then, carrier generating section 28 sets the carrier frequency to a first set frequency fc1 which is a non-audible frequency higher than an audible frequency to reduce the noises generated according to the switching operations of inverter 13b in constant torque region A1 which corresponds to an ordinarily used region during an ordinary traveling of the vehicle, as shown in FIG. 4B. On the other hand, in rotational speed region A2 the high output for electric motor 1, is required and the carrier frequency is set to be lower than that in the constant torque region A1 to reduce a switching loss in inverter 13b.

Specifically, in a middle speed region A3 which is equal to or lower than a predetermined set rotational speed ω2 in rotational speed region A2 is set as a carrier frequency progressive reduction region. In middle speed region A3, the carrier frequency is progressively reduced along with the increase in rotational speed ω. In addition, in a high-speed region A4 exceeding set rotational speed ω2, the carrier frequency is set to a second set frequency fc2 which is the audible frequency. It should be noted that, as both of first and second set frequencies, first set frequency is preferably set to 20 kHz and second set frequency is preferably set to 10 kHz, respectively, with a balance between the noises in inverter 13b and the is switching loss in inverter 13b taken into consideration.

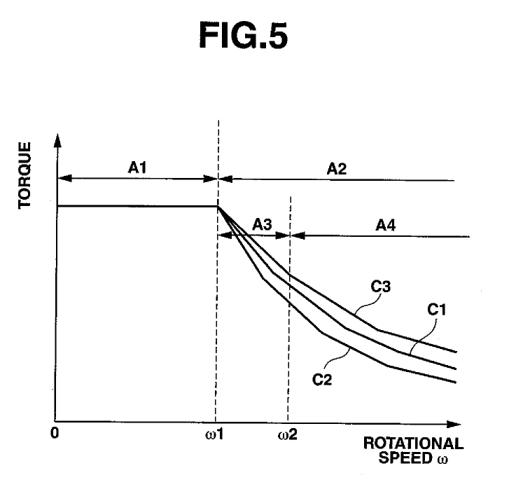

FIG. 5 shows N-T (rotational speed-and-torque characteristics) characteristics in which C1 denotes the N-T characteristic in this embodiment, C2 denotes the N-T characteristic in a first comparative example in which the carrier frequency is set to first set frequency fc1 even in a first comparative example in which the carrier frequency is set to first set frequency fc1 even in rotational speed region A2, and C3 denotes the N-T characteristic in a second comparative example supposing that the switching loss is not present, respectively. As shown in FIG. 5, in this embodiment, in constant torque region A1 demanding no high output for electric motor 1, the increase in the switching loss is allowed in constant torque region A1, and the noises in inverter 13b are reduced by setting the carrier frequency to first set frequency fc1. On the other hand, in rotational speed region A2 demanding the high output for electric motor 1, the switching loss cannot be allowed. Hence, the carrier frequency is reduced to a range up to second set frequency fc2. Thus, the switching loss in inverter 13b is reduced and the torque generable by electric motor 1 is increased to a larger value than that in first comparative example C2. Hence, in this embodiment, the noises of inverter 13b can be reduced by setting the carrier frequency to the non-audible frequency in constant torque region A1 not demanding the high output for electric motor 1. In rotational speed region A2 demanding the high output for electric motor 1, the switching loss is reduced by reducing the carrier frequency up to the audible frequency in rotational speed region A2 demanding the high output for electric motor 1 so that the output of electric motor 1 can be improved.

In addition, since the output of electric motor 1 is improved, small-sized electric motor 1 as is used for the electric power steering apparatus becomes possible. The electric power steering apparatus can become light in weight and can be compacted. In addition, the electric power steering apparatus becomes applicable to a relatively large-sized vehicle.

In addition to the above-described merits, since the carrier frequency can progressively be reduced along with the increase in rotational speed ω in middle speed region A3. A worsening of a steering feeling due to an abrupt (a stepwise) change in the carrier frequency can be prevented.

Furthermore, the driving state of electric motor 1 is determined on a basis of rotational speed ω calculated on a basis of the output (signal) of resolver la built in electric motor 1, a new installation of a sensor to detect a driving state of electric motor 1 is not needed. Thus, the use of the resolver can become cost effective.

### Second Embodiment

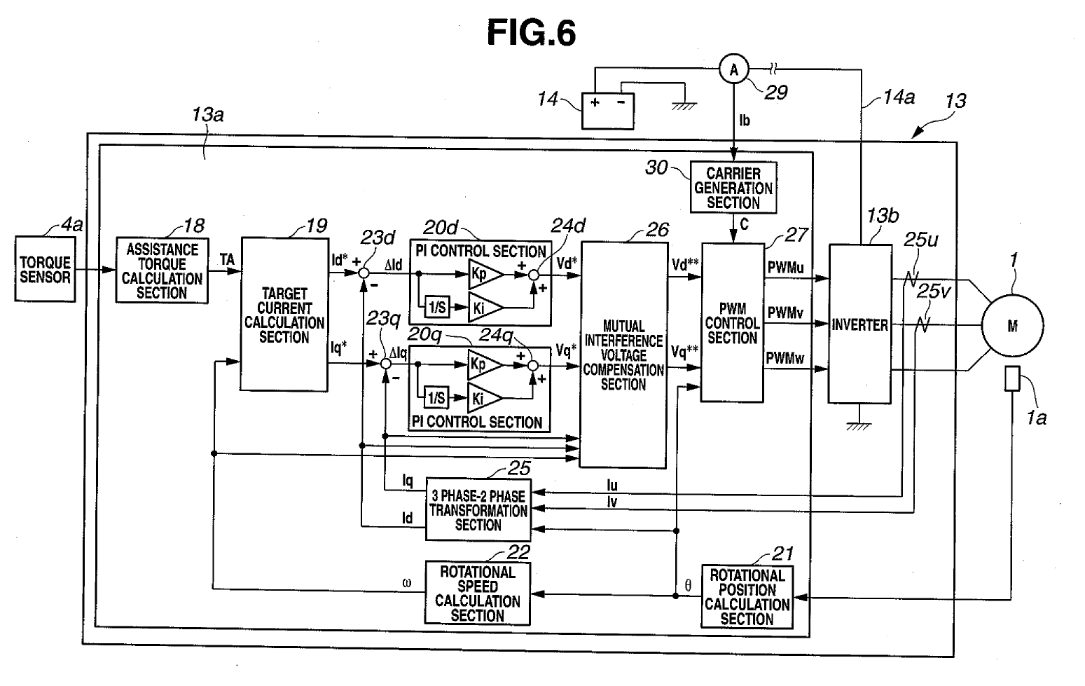

FIG. 6 shows a detailed functional block diagram of control unit 13 representing a second preferred embodiment of the vehicular steering control apparatus according to the present invention. In the second embodiment shown in FIG. 6, current sensor 29 is installed to detect primary current Ib flowing through cable 14a and carrier generating section 30, which is the carrier frequency control section, sets the carrier frequency on a basis of primary current Ib received from current sensor 29. It should be noted that the other parts are the same as the first preferred embodiment described above.

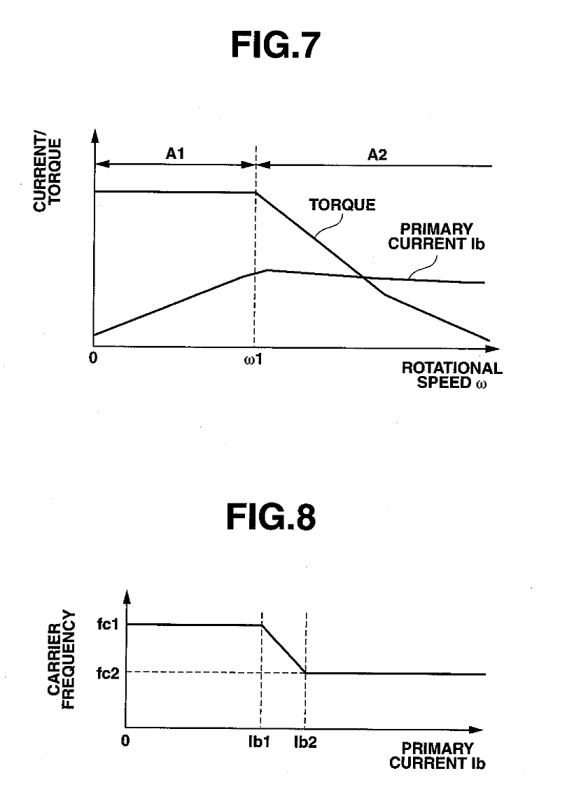

FIG. 7 shows a graph representing a relationship between rotational speed ω and primary current Ib in a case where electric motor 1 is driven at the generable maximum torque together with an N (rotational speed)-T (torque) characteristic of electric motor 1. As shown in FIG. 7, primary current Ib is increased together with the increase in rotational speed ω of electric motor 1 or the output of electric motor 1. In other words, in the second embodiment, a determination of whether electric motor 1 is operated in rotational region A2 is made on a basis of primary current Ib. In a case where electric motor 1 is determined to be driven in rotational speed region A2, the carrier frequency is set to be lower than a case where electric motor 1 is operated in constant torque region A1.

Specifically, as shown in FIG. 8, carrier generating section 30 sets the carrier frequency to first set frequency fc1 in a case where primary current Ib is equal to or smaller than a predetermined first set current Ib1. On the other hand, in a case where primary current Ib is in excess of predetermined set current Ib2, the carrier frequency is set to be second set frequency fc2. Furthermore, in a case where primary current Ib is in excess of first set current Ib1 and is equal to or smaller than second set current Ib2, the carrier frequency is set to be progressively reduced along with the increase in the primary current Ib. It should, naturally, be noted that first set current Ib1 and second set current Ib2 are set to correspond to rotational speed region A2.

Hence, in the second embodiment, when electric motor 1 is operated at rotational speed ω of rotational speed region A2 and during the high output of electric motor 1 in which the generation torque of electric motor 1 is large, the carrier frequency is set to be lower than that when the output of electric motor 1 is low. In other words, even in a case where electric motor 1 is operated at rotational speed ω of rotational speed region A2, the output of electric motor 1 is relatively low even in a case where the generation torque of electric motor 1 is low. Thus, primary current Ib is equal to or below first set current Ib1 and carrier frequency is maintained at first set frequency fc1. In other words, although electric motor 1 is operated at rotational speed ω of rotational speed region A2, in a case where the generation torque of electric motor 1 is low, the increase in the switching loss can be allowed. Hence, the carrier frequency is maintained at first set frequency fc1 to suppress the noises of inverter 13b.

In other words, in the second embodiment of the steering control apparatus, the approximately same effects as those in the first embodiment can be obtained. In addition, a more suitable setting of carrier frequency can be achieved by a more accurate determination of the operating state of electric motor 1.

In other words, in the second preferred embodiment of the vehicular steering control apparatus, the approximately same effects as those in the first embodiment can be obtained. In addition, a more suitable setting of the carrier frequency can be made by a more accurate determination of the driving state of electric motor 1.

It should be noted that, although the carrier frequency is set in accordance with primary current Ib, the carrier frequency may, of course, be set in accordance with both of rotational speed ω of electric motor 1 and primary current Ib thereof.

### Third Embodiment

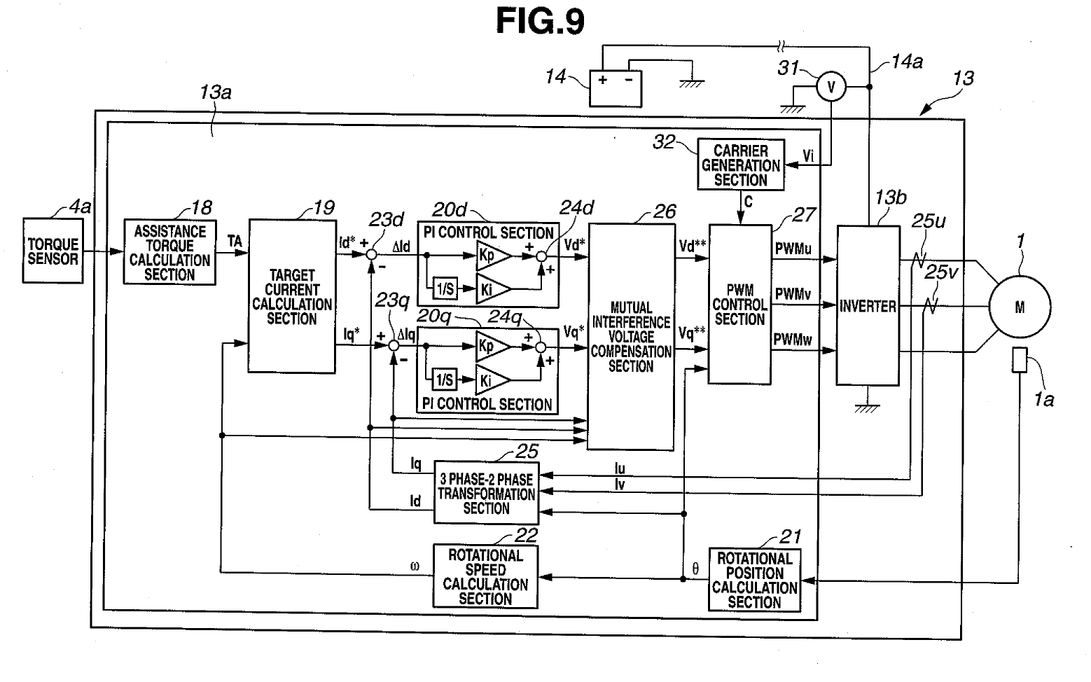

FIG. 9 shows a functional block diagram of control unit 13 representing a third preferred embodiment according to the present invention. A voltage sensor 31 to detect an input voltage Vi to be supplied to inverter 13b is installed in the third embodiment, as shown in FIG. 9. The carrier frequency is set by carrier generating section 32, which is the carrier frequency control section, in accordance with an output of voltage sensor 31. The other parts are approximately the same as those in the first embodiment.

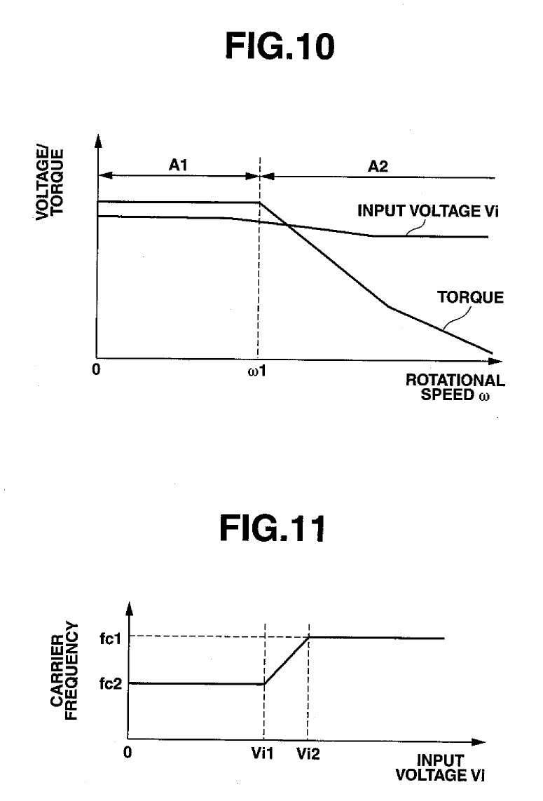

FIG. 10 shows a graph representing a relationship between rotational speed ω and input voltage Vi in a case where electric motor 1 is driven at the maximum generable torque together with the N-T characteristic of electric motor 1. As shown in FIG. 10, if rotational speed ω of electric motor 1 or output thereof is increased, the current flowing through a harness 14a becomes large so that a voltage drop quantity in harness 14a is increased and, thus, input voltage Vi is reduced. In this way, since input voltage Vi is varied in accordance with rotational speed ω of electric motor 1 or the output thereof. In this embodiment, a determination of whether electric motor 1 is operated in rotational speed region A2 or not is made on a basis of input voltage Vi. In a case where electric motor 1 is driven in rotational speed region A2, the carrier frequency is set to be lower than that when electric motor 1 is driven in constant torque region A1.

Specifically, as shown in FIG. 11, the carrier frequency is set to second set frequency fc2 in a case where input voltage Vi is equal to or below a predetermined first set voltage Vi1. On the other hand, in a case where input voltage Vi is in excess of predetermined second set voltage Vi2, the carrier frequency is set to first set frequency fc1. Furthermore, carrier generating section 32 progressively reduces the carrier frequency along with a decrease in input voltage Vi, in a case where input voltage Vi is in excess of first set voltage Vi1 and is equal to or lower than second set voltage Vi2. Naturally, first set voltage Vi1 and second set voltage Vi2 are set to correspond to rotational speed region A2.

Hence, in this third embodiment, during a high output of electric motor 1 in which the generation torque of electric motor 1 is large while electric motor 1 is driven at rotational speed ω in rotational speed region A2, in the same way as the second preferred embodiment, carrier generating section 32 sets the carrier frequency to be lower than that during a time at which the low output of electric motor 1. The approximately same effects as those during the low output of electric motor 1 can be obtained.

It should be noted that, in the embodiment, the carrier frequency is set by carrier generating section 32 in accordance with input voltage Vi. However, since a case where input voltage Vi is varied due to a voltage variation in accordance with a deterioration in battery 14 and in accordance with a charge state is supposed, in order to determine more accurately the driving state of electric motor 1, the carrier frequency may be set in accordance with a difference between voltage across battery 14 and input voltage Vi, namely, the carrier frequency may be set in accordance with a voltage drop quantity in harness 14a.

### Fourth Embodiment

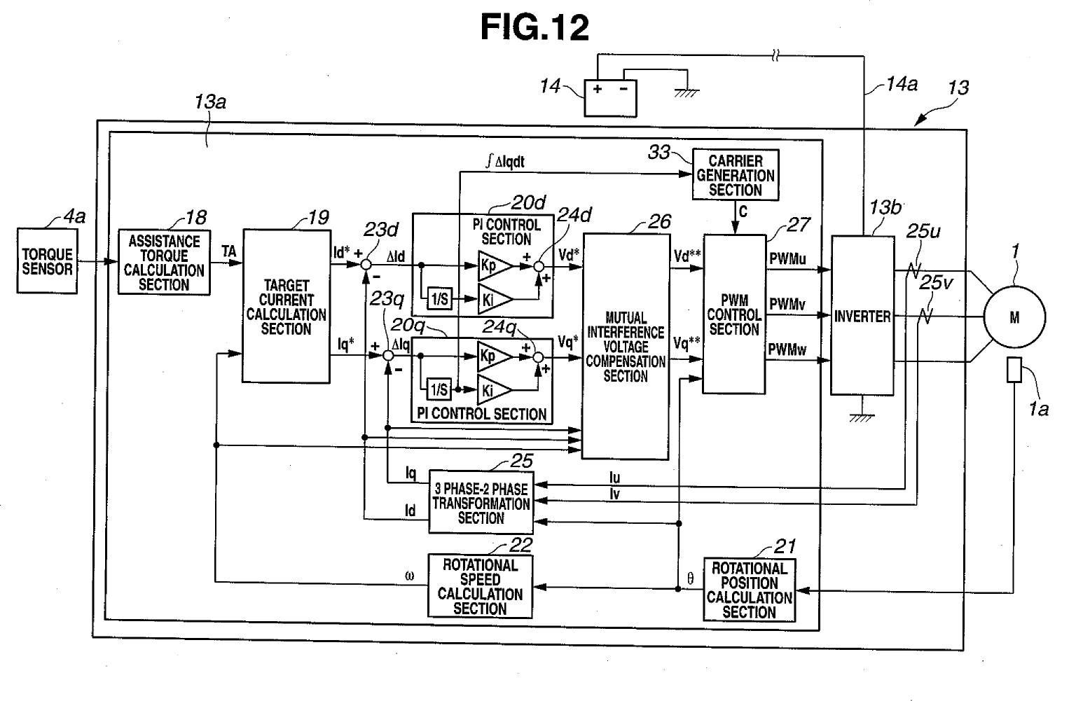

In a fourth preferred embodiment shown in FIG. 12, carrier generating section 33 which is the carrier frequency control section sets the carrier frequency on a basis of an integration value of ∫ΔIqdt of a q-axis current deviation calculated by PI control section 20q on the q-axis current deviation calculated at q-axis PI control section 20q.

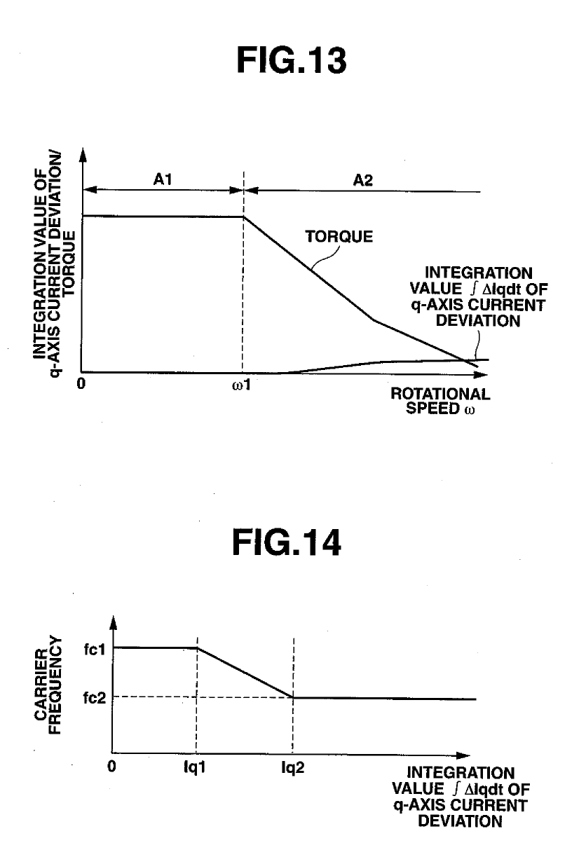

FIG. 13 shows a graph representing a relationship between rotational speed ω and integration value of ∫ΔIqdt of the q-axis current deviation in a case where electric motor 1 is driven at the generable maximum torque together with the N-T characteristic of electric motor 1. As shown in FIG. 13, if rotational speed ω of electric motor 1 or the output of electric motor 1 is increased, integration value ∫ΔIqdt of q-axis current deviation rises due to an output saturation at rotational speed ω, in rotational speed region A2. Then, integration value ∫ΔIqdt of q-axis current deviation is increased along with further increase in rotational speed ω of electric motor 1.

In this way, since integration value ∫ΔIqdt of the q-axis current deviation is varied in accordance with rotational speed ω of electric motor 1. Hence, in the fifth embodiment, the determination of whether electric motor 1 is operated in rotational speed region A2 is made on the basis of integration value ∫ΔIqdt of the q-axis current deviation. If electric motor 1 is operated in rotational speed region A2, the carrier frequency is se to be lower than that when electric motor 1 is operated at constant torque region A1.

Specifically, as shown in FIG. 14, carrier generating section 34 sets the carrier frequency to first set frequency Iq1 in a case where integration value of ∫ΔIqdt of q-axis current deviation is equal to or lower than a predetermined set current deviation Iq1. On the other hand, in a case where integration value ∫ΔIqdt of q-axis current deviation is in excess of predetermined second set current deviation Iq2, the carrier frequency is set to second set frequency fc2.

Furthermore, carrier generating section 34 sets the carrier frequency to be progressively reduced along with the increase in the integration value of ∫ΔIqdt in a case where integration value ∫ΔIqdt is in excess of the first set current deviation Iq1 and is equal to or below second set current deviation Iq2.

It is natural that first set current deviation Iq1 and second set current deviation Iq2 are set to correspond to rotational speed region A2.

Hence, even in the fourth embodiment, in the same way as the second embodiment, the carrier frequency when electric motor 1 is operated at rotational speed co in the rotational speed region A2 and the output of electric motor 1 is high (the generation torque of electric motor 1 is large) is set to be lower than a case where the output of electric motor 1 is low. Thus, the approximately same advantages as the second embodiment can be obtained.

### Fifth Embodiment

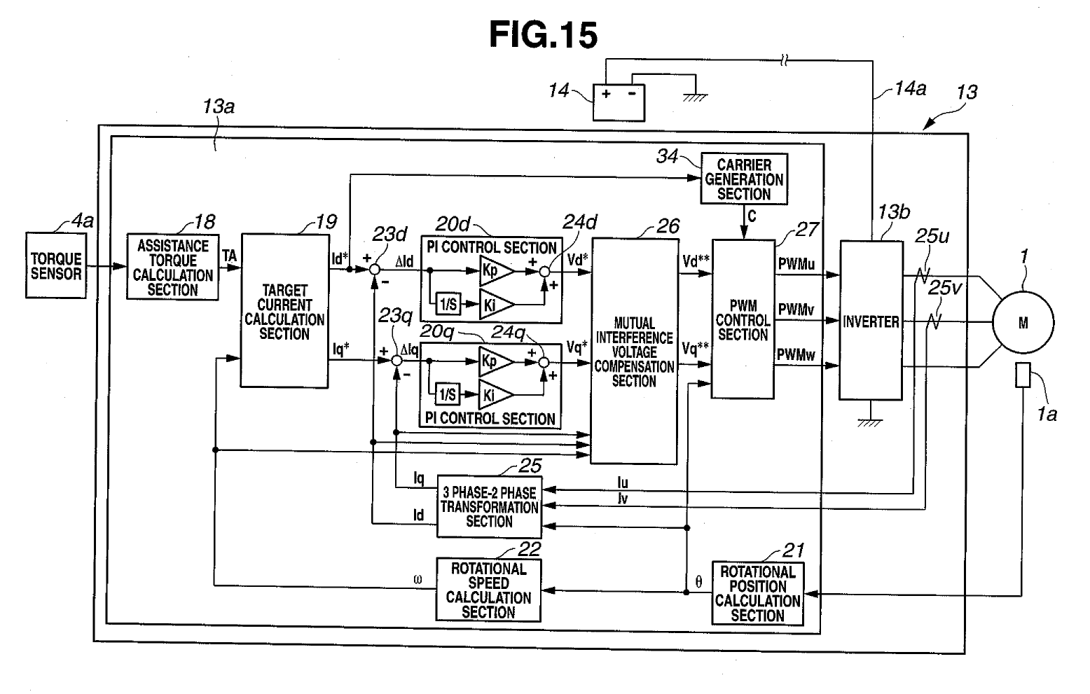

In the fifth embodiment shown in FIG. 15, carrier generating section 34 as the carrier frequency control section varies the carrier frequency on a basis of a d-axis target current Id*. The other parts are the same as those shown in the first embodiment.

It should be noted that a d-axis target current Id* is, so-called, a field-weakening current which is increased along with the increase in rotational speed ω of electric motor 1. In this embodiment, target current calculation section 19 calculates d-axis target current Id* in the following equation.

Id*=(ω−ωd)×Iq*×control coefficient

ωd in the equation described above is a field-weakening control start rotational speed to start the field-weakening control. In other words, target current calculating section 19 generates d-axis target current Id* in a case where rotational speed ω of electric motor 1 is in excess of the field-weakening control start rotational speed ωd.

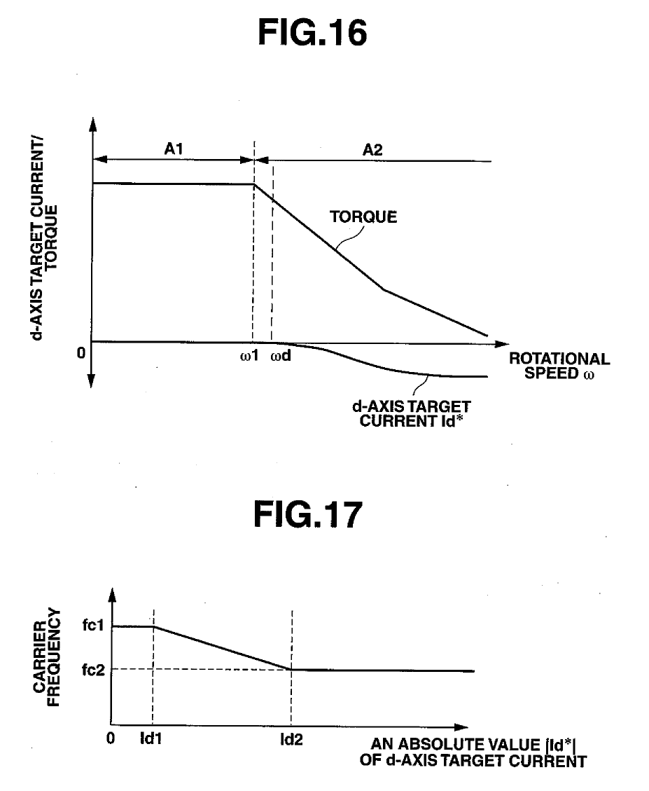

FIG. 16 shows a graph representing a relationship between rotational speed ω and d-axis target current Id* together with the N-T characteristic of electric motor 1 in a case where electric motor 1 is driven at the generable maximum torque. With reference to FIG. 16, d-axis target current Id* will be explained in more details. Rotational speed ω in electric motor 1 is increased and has reached to a field-weakening control start rotational speed ωd set to rotational speed of rotational speed region A2. At this time, the field-weakening control is started and an absolute value |Id*| of d-axis target current along with the increase in rotational speed ω of electric motor 1 from field control start rotational speed ωd is increased. In the way described above, d-axis target current Id* is varied in accordance with rotational speed ω of electric motor 1. In the fifth embodiment, a determination of whether electric motor 1 is operated in rotational speed region A2 is made on a basis of d-axis target current Id*. In a case where electric motor 1 is operated in rotational speed region A2, the carrier frequency is set to be lower than that when electric motor 1 is operated in constant torque region A1.

Specifically, as shown in FIG. 17, carrier generating section 34 sets the carrier frequency to first set frequency fc1 in a case where absolute value |Id*| of d-axis target current is equal to or smaller than predetermined first set target current Id1. On the other hand, absolute value |Id*| of d-axis target current is in excess of predetermined second set target current Id2, the carrier frequency is set to second set frequency fc2. Furthermore, carrier generating section 34 sets the carrier frequency to be progressively reduced along with the increase in |Id*| of d-axis target current in a case where absolute value |Id*| of d-axis target current is in excess of first set target current Id1 and is equal to or below second set target current Id2. It is natural that both of set target currents Id1, Id2 correspond to rotational speed region A2.

Hence, in the fifth embodiment, electric motor 1 is operated at rotational speed ω in rotational speed region A2, in the same way as the second embodiment. In addition, during a time at which the generation torque of electric motor 1 is large, the carrier frequency is set to be lower than the time at which electric motor 1 is low. The approximately same effects as those operated in the second embodiment can be set.

### Sixth Embodiment

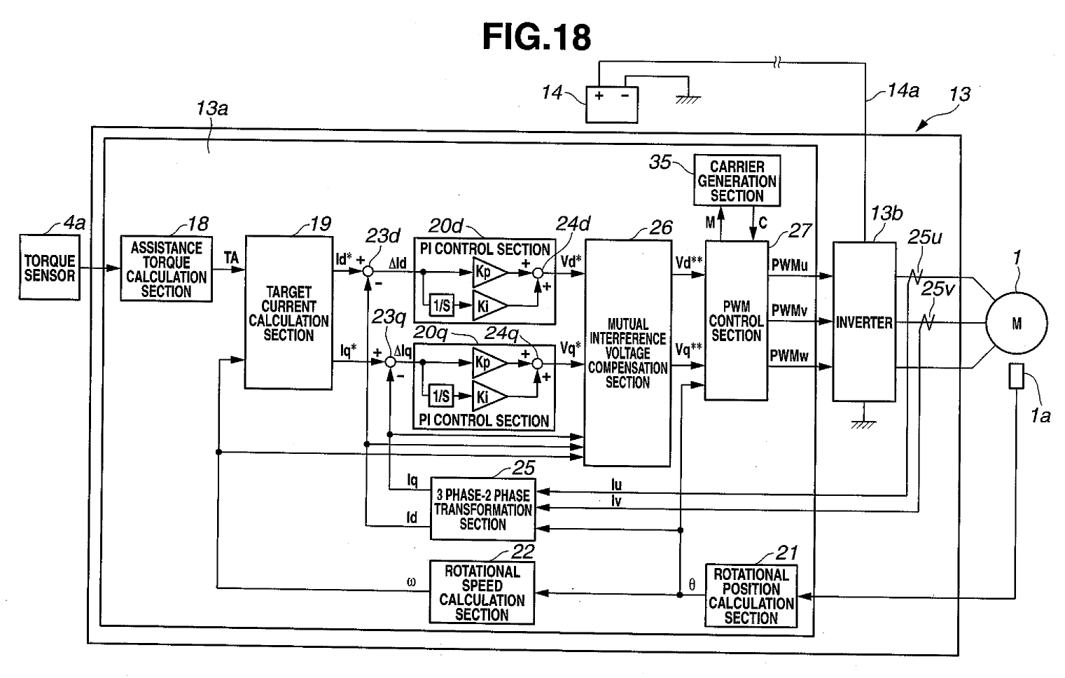

In a sixth preferred embodiment shown in FIG. 18, carrier generating section 35 which is the carrier frequency control section varies the carrier frequency in accordance with a modulation rate M which provides a generation basis for PWM control signals PWMu, PWMv, and PWMw, namely, varies the carrier frequency in accordance with the target supply voltage for electric motor 1. The other parts are the same as those in the first embodiment. In other words, modulation rate M is increased as the rotational speed ω of electric motor 1 or the output thereof is increased. Hence, in the sixth embodiment, the determination of whether electric motor 1 is operated in rotational speed region A2 is made on a basis of modulation rate M. In a case where electric motor 1 is operated in rotational speed region A2, the carrier frequency is set to be lower than that when electric motor 1 is operated in constant torque region A1.

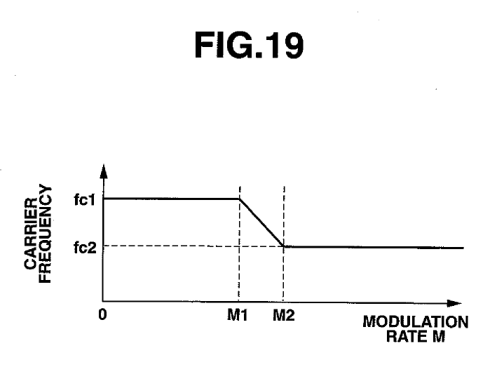

Specifically, as shown in FIG. 19, carrier generating section 35 sets the carrier frequency to a first set frequency fc1 in a case where modulation rate M is equal to or below first set modulation rate M1 and sets the carrier frequency to second set frequency fc2 in a case where modulation rate M is in excess of second set modulation ratio M2. Furthermore, carrier generating section 35 progressively reduces the carrier frequency along with the increase in modulation rate M. It is of course that both set modulation rates M1, M2 are set to rotational speed region A2. More specifically, first set modulation rate M1 is set to 100% and second modulation rate M2 is set to 120%, respectively.

Hence, in the sixth embodiment, in the same way as the second embodiment, when electric motor 1 is operated at rotational speed ω in rotational speed region A2 and a high output time at which the generation torque of electric motor 1 is large, the carrier frequency is set at the carrier frequency to be lower than that during a time at which the generation torque is large, generally the same effects as the second embodiment can be obtained.

### Seventh Embodiment

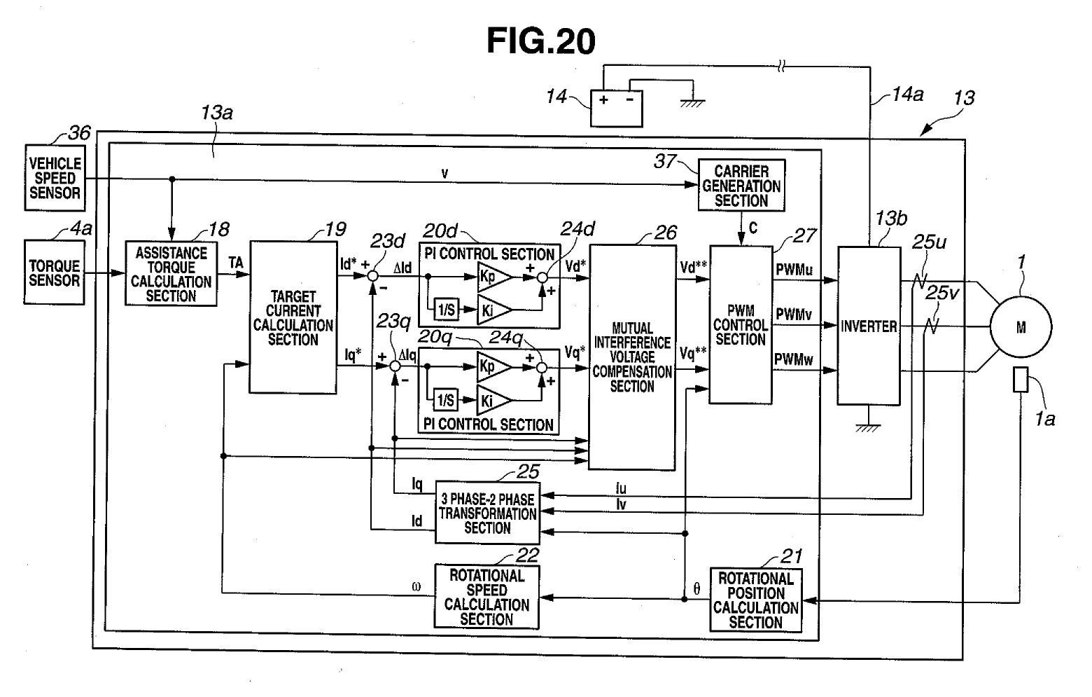

FIG. 20 shows a seventh preferred embodiment of the vehicular steering control apparatus according to the present invention. In the seventh embodiment according to the present invention, a vehicle speed sensor 36 to detect a traveling speed v of vehicle is newly installed. In the seventh embodiment, carrier generating section 37 which is the carrier frequency control section varies the carrier frequency on a basis of an output of vehicle speed sensor 36. In addition, the output of vehicle speed sensor 36 is provided for assistance torque calculation section 18. Assistance torque calculation section 18 increases the target assistance torque TA along with the reduction in traveling speed v. It should be noted that the other parts are generally the same as the first embodiment.

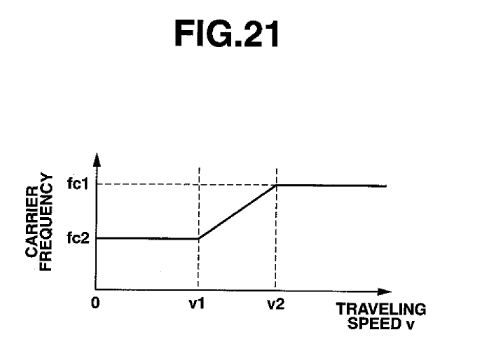

Carrier generating section 37 in the seventh embodiment sets the carrier frequency to second set frequency fc2 in a case where traveling speed v of the vehicle is equal to or lower than a predetermined first set traveling speed v1 as shown in FIG. 21. On the other hand, in a case where traveling speed v of the vehicle is in excess of a predetermined second set traveling speed v2, the carrier frequency is set to first set traveling speed fc1. Furthermore, carrier generating section 37 progressively reduces the carrier frequency along with the decrease in traveling speed v in a case where traveling speed v of the vehicle is in excess of first set traveling speed v1 and is equal to or below second set traveling speed v2.

In other words, during a low-speed traveling of the vehicle or a stop thereof, the high output is required for electric motor 1 in order to generate the large assistance torque. At this time, the switching loss in inverter 13b is reduced to reduce the carrier frequency and the output of the electric motor 1 is increased in order to generate the large assistance torque along with the reduction in traveling speed v. It is preferable to set first set traveling speed v1 and second set traveling speed v2 appropriately, and more specifically, with the relationship between traveling speed v and the steering force taken into consideration, first set traveling speed v1 may preferably be set to 5 km/h and second set traveling speed v2 may preferably be set to 10 km/h, respectively.

Hence, in the seventh embodiment, during the low-speed traveling of the vehicle and during the stop thereof, the high output for electric motor 1 is required. The carrier frequency is set to be low. The output of electric motor 1 can be improved. On the other hand, during the high speed traveling of the vehicle in which no high output is required for electric motor 1. At this time, the carrier frequency is set to be high and the noises of the inverter can be reduced.

### Eighth Embodiment

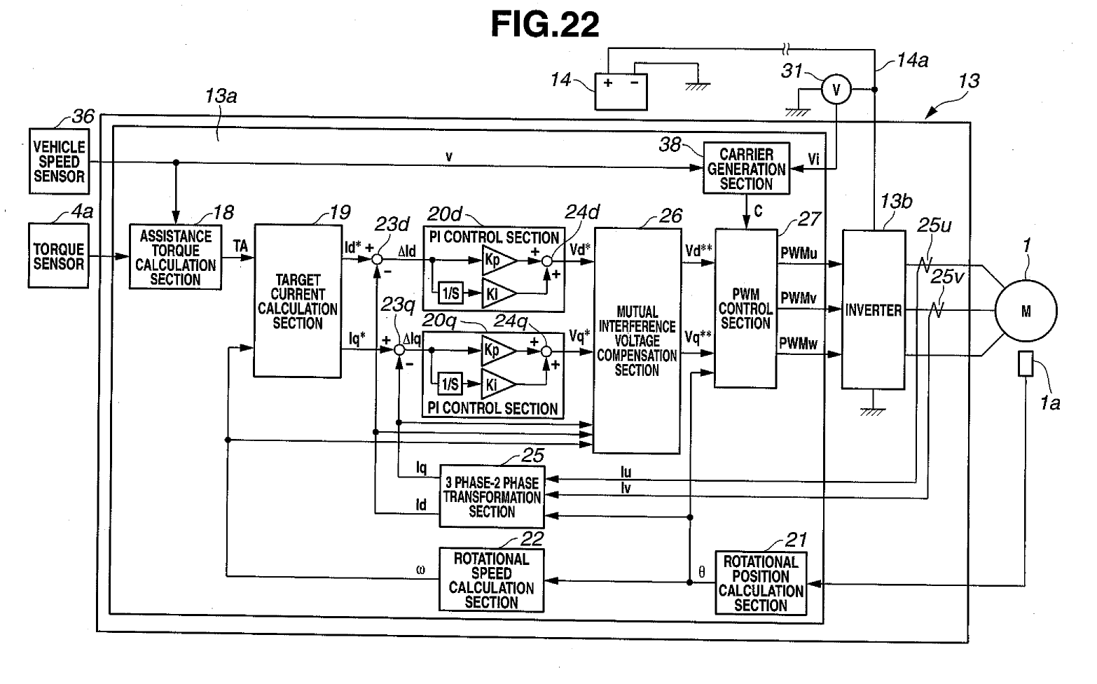

An eighth preferred embodiment shown in FIG. 22 is an addition of voltage sensor 31 in the third embodiment, with the seventh preferred embodiment as a base. Carrier generating section 38 varies the carrier frequency in accordance with their outputs of vehicle speed sensor 36 and voltage sensor 31. The other parts are generally the same as those described in the seventh embodiment.

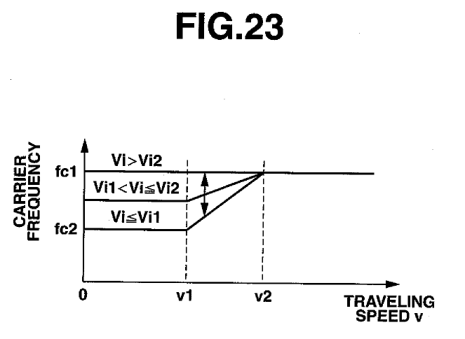

Specifically, as shown in FIG. 23, carrier generating section 38 reduces the carrier frequency along with the reduction of input voltage Vi in a case where traveling speed v of the vehicle is equal to or below second set vehicle speed v2. In other words, during the high output of electric motor 1, input voltage Vi is reduced as described above so that the carrier frequency is set in accordance with this input voltage Vi.

In more details, in a case where input voltage Vi is in excess of second set voltage Vi2, the high output is required for electric motor 1. Thus, even if traveling speed v of the vehicle is equal to or below second set traveling speed v2, the carrier frequency is maintained at first set frequency fc1 to reduce the noises of inverter 13b. On the other hand, in a case where traveling speed v of the vehicle is equal to or below first set traveling speed v1 and input voltage Vi is equal to or below first set voltage Vi1, the high output is required for electric motor 1. Thus, the carrier frequency is set to second set frequency fc2. Furthermore, in a case where traveling speed v of the vehicle is equal to or below second set vehicle speed v2 and input voltage Vi is in excess of first set voltage Vi1 and is equal to or below second set voltage V2, the carrier frequency is progressively reduced along with the reduction in input voltage Vi.

Hence, in the eighth embodiment, in addition to obtain generally the same advantages as the seventh embodiment, carrier generating section 38 sets the carrier frequency in accordance with input voltage Vi in addition to traveling speed v of the vehicle. The carrier frequency can appropriately be set in accordance with the traveling state (driving state) of the vehicle.

### Ninth Embodiment

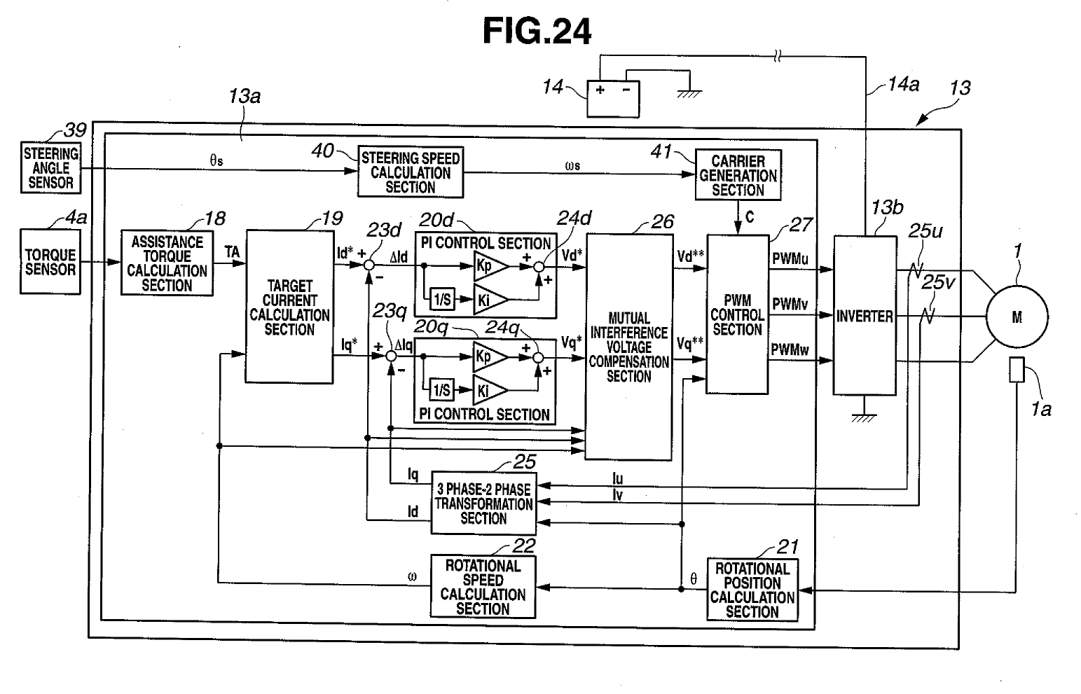

In a ninth embodiment shown in FIG. 24, a steering angle sensor 39 which detects a rotational position θ of steering wheel 4, a steering speed calculation section 40 which calculates a steering speed ωs which is the rotational speed of steering wheel 4 on a basis of steering angle θs which is the output of steering angle sensor 3 are respectively installed. Carrier generating section 41 varies the carrier frequency on a basis of steering speed ωs. The other parts are generally the same as those described in the first embodiment.

In other words, in the ninth embodiment described herein, in a case where steering speed ωs, for example, is large during the object collision avoidance traveling, the high output is required for electric motor 1. Thus, the switching loss is reduced by setting the carrier frequency to be lowered. Thus, the output of the electric motor 1 is increased while steering speed ωs is low in a case during the ordinary driving. Thus, the noises of inverter 13b are reduced while the carrier frequency is set to be increased.

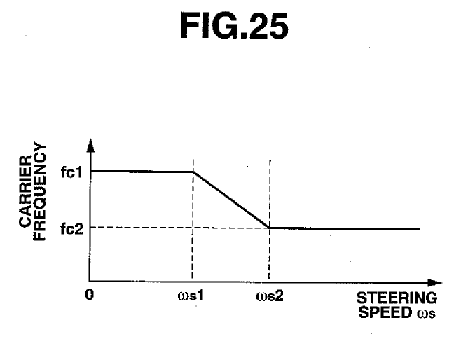

More specifically, as shown in FIG. 25, carrier generating section 41 sets the carrier frequency to first set frequency fc1 in a case where steering speed ωs is equal to or below a predetermined first set steering speed ωs1 and sets the carrier frequency to predetermined second set frequency fc2 in a case where steering speed ωs is in excess of a predetermined second steering speed ωs2 Furthermore, carrier generating section 41 progressively reduces the carrier frequency along with the increase in steering speed ωs in a case where steering speed ωs is in excess of the first set steering speed ωs1 and is equal to or below second set steering speed ωs2, It should be noted that, as set steering speeds ωs1,ωs2, since steering speed ωs during the object collision avoidance traveling ranges from 200 deg/sec to 400 deg/sec, first set steering speed ωs1 may be set to 200 deg/sec and second set steering speed ωs2 may be set to 300 deg/sec.

Hence, according to the ninth preferred embodiment, the carrier frequency is set to be low during the object collision avoidance traveling requiring the high output for electric motor 1 to improve the output of electric motor 1. On the other hand, during the ordinary driving, the carrier frequency is set to be high so that the noises in inverter 13b can be reduced.

It should be noted that, in the ninth embodiment, steering speed calculation section 40 calculates steering speed ωs on a basis of the output of steering angle sensor 39. However, this steering speed ωs is proportional to rotational speed ω of electric motor 1. Thus, it is possible to calculate steering speed ωs on a basis of rotational speed ω of electric motor 1. In this case, steering angle sensor 39 is not needed. Thus, it becomes cost-effective and there is an advantage that compacting and light-weighting of the vehicular steering control apparatus become achieved.

### Tenth Embodiment

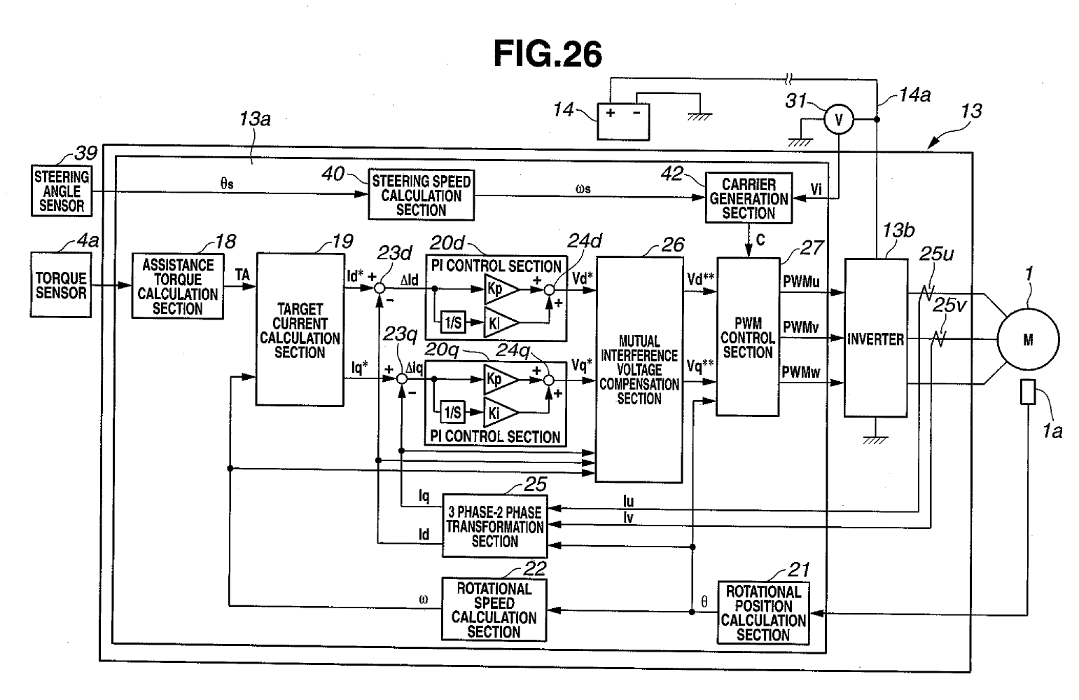

In a tenth preferred embodiment shown in FIG. 26, voltage sensor 31 in the third embodiment is newly installed with the ninth preferred embodiment as a base and carrier generating section 42 varies the carrier frequency in accordance with steering speed ωs and input voltage Vi, respectively. It should be noted that the other parts are generally the same as those described in the ninth embodiment.

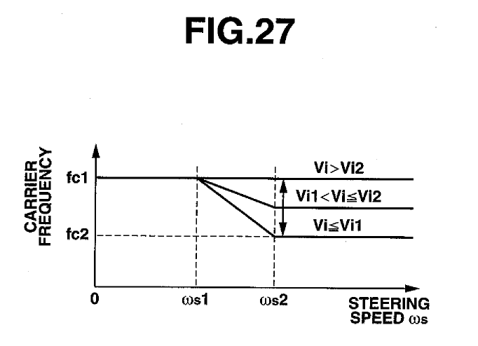

Specifically, as shown in FIG. 27, carrier generating section 38 reduces (or lowers) the carrier frequency in a case where steering speed ωs is equal to or higher than first set steering speed ωs1. In details, since, during the high output of electric motor 1, input voltage Vi is reduced, the carrier frequency is set in accordance with this input voltage Vi.

In more details, in a case where input voltage Vi is in excess of second set voltage Vi2, the high output is not required for electric motor 1. Hence, even if steering speed ωs is in excess of first set steering speed ωs1, the carrier frequency is maintained at first set frequency fc1 to reduce the noises of inverter 13b. On the other hand, in a case where steering speed ωs is equal to or lower than second steering speed ωs2 and input voltage Vi is equal to or lower than first set voltage Vi1, the high output is required for electric motor 1. In this case, the carrier frequency is set to second set frequency fc2. Furthermore, in a case where steering speed ωs is in excess of first set steering speed ωs1 and input voltage Vi is in excess of first set voltage Vi1 and is equal to or lower than second set voltage V2, the carrier frequency is progressively reduced along with the reduction in input voltage Vi.

Hence, in the tenth embodiment, generally the same advantages as the above-described ninth embodiment can be obtained. In addition, since carrier generating section 42 sets the carrier frequency in accordance with input voltage Vi in addition to steering speed ωs. Hence, the carrier frequency can more appropriately be set in accordance with the traveling state of the vehicle.

### Eleventh Embodiment

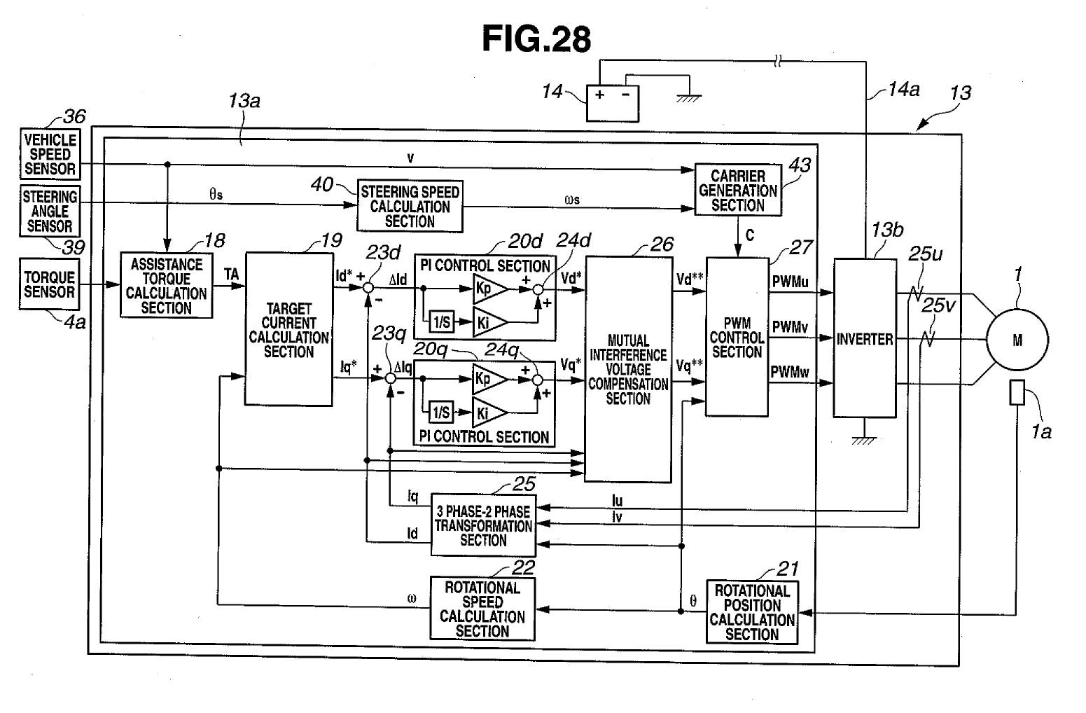

In an eleventh embodiment shown in FIG. 28, a combination of vehicle speed sensor 36 described in the seventh embodiment with steering angle sensor 39 and steering speed calculation section 40 described in the ninth embodiment is used. Carrier generating section 43 which is the carrier frequency control section varies the carrier frequency in accordance with traveling speed v of the vehicle and in accordance with steering speed ωs thereof, respectively. The other parts are generally the same as those in the seventh embodiment described above.

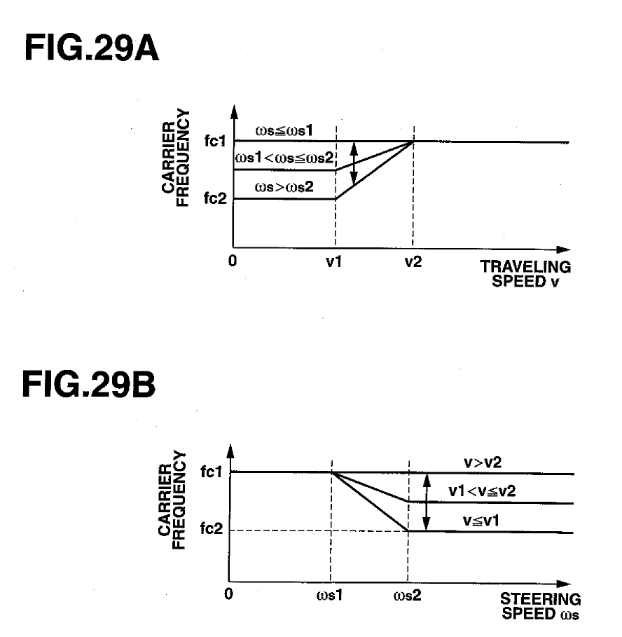

Specifically, in the eleventh embodiment, as shown in FIGS. 29A and 29B, carrier generating section 43 reduces (or lowers) the carrier frequency along with the increase in steering speed ωs in a case where traveling speed v of the vehicle is equal to or lower than second set traveling speed v2. FIG. 29(A) shows a graph indicating a carrier frequency map with traveling speed v taken along the lateral axis. FIG. 29(B) shows a graph indicating a carrier frequency map with steering speed ωs taken along the lateral axis.

More specifically in a case where steering speed ωs is equal to or lower than first set steering speed ωs1, the high output is not required for electric motor 1. Hence, even if traveling speed v of the vehicle is equal to or lower than second set steering speed v2, the carrier frequency is maintained at first set frequency fc1 to reduce the noises in the inverter. On the other hand, if traveling speed v of the vehicle is equal to or lower than first set traveling speed v1 and steering speed ωs is in excess of second set steering speed ωs2, the high output for electric motor 1 is required. Hence, the carrier frequency is set to second set frequency fc2. Furthermore, in a case where traveling speed v of the vehicle is equal to or below second set traveling speed v2 and steering speed ωs is in excess of first set steering speed ωs1 and is equal to or lower than second set steering speed ωs2, the carrier frequency is progressively reduced along with the increase in steering speed ωs.

Hence, in the eleventh embodiment, the same advantages as those in the case of the seventh embodiment can be obtained. In addition, carrier generating section 43 sets the carrier frequency in accordance with traveling speed v and steering speed ωs. Hence, a more appropriate setting of the carrier frequency can be achieved in accordance with the traveling state of the vehicle.

Hence, in the eleventh embodiment, generally the same advantages as those in the seventh embodiment can be obtained. In addition, carrier generating section 43 approximately sets the carrier frequency in accordance with steering speed ωs in addition to traveling speed v of the vehicle. Hence, the carrier frequency can more appropriately be set in accordance with the traveling state of the vehicle.

It should, herein, be noted that a technical concept grasped from each of the first through eleventh embodiments will be described hereinbelow.

(1) The vehicular steering control apparatus as claimed in claim 3, wherein the rotational speed determination section determines the rotational speed of the electric motor on a basis of an output signal of a resolver built in the electric motor.

According to the above-described matter, a new sensor to detect the rotational speed of the electric motor is not needed so that it is effective in terms of a cost in manufacture.

(2) The vehicular steering control apparatus as claimed in claim 2, wherein the vehicular steering control apparatus further comprises: a power supply connected to the inverter via a cable to supply an electric power to the inverter; and a voltage sensor configured to detect an input voltage of the inverter and wherein the carrier frequency control section is configured to set the carrier frequency when the input voltage of the inverter is equal to or lower than a predetermined set voltage to be lower than that in a case where the input voltage of the inverter is in excess of the predetermined set voltage.

According to the structure described in item (2), a voltage drop quantity in the cable is increased according to an increase in the current flowing through the cable. Thus, the input voltage of the inverter is reduced to be lower than a power supply voltage. Hence, a determination of whether the electric motor is operated in a rotational speed region higher than that in the constant torque region is made on a basis of the input voltage of the inverter. Hence, according to the structure described above, the carrier frequency can appropriately be set in accordance with the driving state of the electric motor.

(3) The vehicular steering control apparatus as claimed in claim 2, wherein a DC power supply connected via the cable to the inverter to supply the electric power to the inverter and a current sensor to detect a primary current flowing through the cable are installed and the carrier frequency control section sets the carrier frequency when the primary current is in excess of a predetermined set current to be lower than a case where the primary current is equal to or lower than the set current.

According to this structure described in item (3), the primary current is increased when a high output is demanded for the electric motor. Thus, a determination of whether the electric motor is operated in the rotational speed region higher than the constant torque region is based on the primary current. Hence, according to the structure described above, the appropriate carrier frequency can be set in accordance with the driving state of the vehicle.

(4) The vehicular steering control apparatus as claimed in claim 2, wherein the vehicular steering control apparatus further comprises: a target current calculation section configured to calculate a target current to be to supplied to the electric motor; an actual current sensor configured to detect an actual current flowing through the electric motor; a current deviation calculation section configured to calculate a current deviation which indicates a difference between the target current and the actual current and which provides a basis of the calculation of the manipulated variable of the electric motor, wherein the carrier frequency control section sets the carrier frequency when the current deviation is in excess of the predetermined set current deviation to be lower than a case where the current deviation is equal to or lower than the set current deviation.

According to the structure described in item (4), since the current deviation is increased when the high output is demanded for the electric motor, a determination of whether the electric motor is operated in the rotational speed region higher than the constant torque region is made on a basis of the current deviation. Hence, according to the structure described above, the carrier frequency can appropriately be set in accordance with the driving state of the electric motor.

(5) The vehicular steering control apparatus as claimed in claim 2, wherein the vehicular steering speed control apparatus further comprises a target current calculation section configured to calculate a q-axis target current which is in the rotation direction of the electric motor in the rotational coordinate frame and a d-axis target current orthogonal to the q-axis in the rotational reference frame, both q-axis target current and q-axis target current as a base of calculation of the manipulated variable, wherein the target current calculation section varies the d-axis target current in accordance with the rotation direction of the electric motor and the field-weakening control to weaken the field of the electric motor is carried out and where the carrier frequency control section sets the carrier frequency on a basis of the d-axis target current.

According to the structure described in item (5), the d-axis target current is varied in accordance with the rotational speed of electric motor. Hence, a determination whether the electric motor is operated in a rotational speed region which is higher than the constant torque region is made on a basis of the d-axis target current. Hence, according to the structure, the carrier frequency can appropriately be set in accordance with the driving state of the motor.

(6) The vehicular steering control apparatus as set forth in item (5), wherein the target current calculation section generates the d-axis target current in a case where the rotational speed of the electric motor is in excess of a predetermined field weakening control start rotational speed and the field weakening control start rotation speed is set in a rotational speed region in which rotational speed is higher than the constant torque region.

According to the above-described matter described in item (6), since the field weakening control start rotational speed is set to the rotational speed region in which the rotational speed is higher than that in the constant torque region, a determination of whether the electric motor is operated in a region higher than the constant torque region can more accurately be determined.

(7) The vehicular steering control apparatus as claimed in claim 2, wherein the carrier frequency control section is configured to set the carrier frequency when a modulation rate of the PWM control in the PWM control section is in excess of a predetermined set rate of the modulation to be lower than a case where the modulation rate is equal to or lower than the set modulation rate.

According to the structure described in item (7), since the modulation rate is increased when the high output of the electric motor is required, a determination of whether the electric motor is operated in a rotational speed region higher than the constant torque region is made on a basis of the modulation rate. According to the structure described above, the appropriate setting of the carrier frequency may be made in accordance with the driving state of the electric motor.

(8) The vehicular steering control apparatus as claimed in claim 2, wherein the carrier frequency control section sets the carrier frequency to a non-audible frequency which is higher than an audible frequency when the electric motor is driven in the constant torque region.

According to the structure described in item (8), since the carrier frequency is set to the non-audible frequency in the constant torque region not requiring the high output for the electric motor, allowing the increase in the switching loss. Consequently, the noises of the inverter which are involved in the drive of the electric motor can be reduced.

(9) The vehicular steering control apparatus as claimed in claim 5, wherein the vehicular steering control apparatus further comprises: a steering wheel linked to the steering mechanism; and a steering speed determination section configured to determine the steering speed which is the rotational angular velocity of the steering wheel, wherein the carrier frequency control section is configured to reduce the carrier frequency along with the increase in the steering speed in a case where the traveling speed of the vehicle is equal to or lower than the set traveling speed.

According to the structure described in item (9), since the output required for the electric motor is increased along with the increase in the steering speed, the carrier frequency can be set more appropriately with the steering speed taken into consideration. Hence, according to this structure described in item (9), the more appropriate setting in accordance with the traveling state of the vehicle can be made.

(10) The vehicular steering control apparatus as claimed in claim 5, wherein the vehicular steering control apparatus further comprises: a DC power supply from which an electric power is supplied to the inverter to which a cable is connected from the DC power supply; and a voltage sensor configured to detect an input voltage of the inverter and wherein the carrier frequency control section reduces the carrier frequency along with the reduction of the input voltage in a case where the traveling speed is equal to or lower than the set traveling speed.

According to the structure described item (10), since the generable torque for the electric motor is reduced when the input voltage is reduced, the carrier frequency is set with the input voltage taken into consideration in addition to the traveling speed of the vehicle. Hence, according to the structure described above, the carrier frequency can more appropriately be set in accordance with the driving state of the vehicle.

(11) The vehicular steering control apparatus as claimed in claim 5, wherein the carrier frequency control section sets the carrier frequency to the non-audible frequency higher than the audible frequency in a case where the traveling speed is in excess of the set traveling speed.

According to the structure described in item (11), in a case where the traveling speed of the vehicle is in excess of the set traveling speed, the high output is not required for the electric motor. Thus, in this case, the carrier frequency is set to the non-audible frequency allowing the increase in the switching loss. The noises of the inverter generated along with the drive of the electric motor.

(12) The vehicular steering apparatus as claimed in claim 6, wherein the steering speed determination section calculates a steering speed on a basis of an output of a steering sensor configured to detect a rotational position of the steering wheel.

According to the structure described in item (12), the steering speed can be easily be achieved.

(13) The vehicular steering apparatus as claimed in claim 6, wherein the vehicular steering apparatus further comprises a vehicle speed sensor configured to detect a traveling speed of the vehicle and output the detected traveling speed to the carrier frequency control section and the carrier frequency control section reduces the carrier frequency along with the reduction of the traveling speed in a case where the steering speed is in the predetermined set steering speed.

According to the structure described in item (13), since the output required for the electric motor is increased along with the reduction of the traveling speed of the vehicle, with the traveling speed of the vehicle taken into account in addition to the steering speed, the carrier frequency is set. Hence, according to the structure described in item (13), the carrier frequency can more appropriately be set in accordance with the traveling state of the vehicle.

(14) The vehicular steering control apparatus as claimed in claim 6, wherein the vehicular steering control apparatus further comprises: a power supply connected to the inverter via a cable to supply an electric power to the inverter; and a voltage sensor configured to detect an input voltage of the inverter and output the detected input voltage to the carrier frequency control section and the carrier frequency control section reduces the carrier frequency along with the reduction of the input voltage.

According to this structure of item (14), since the input voltage becomes lower, the torque generable by the electric motor is reduced.

Hence, the carrier frequency is set with the input voltage taken into consideration in addition to the steering speed, Hence, according to this structure, the carrier frequency is more appropriately set.

(15) The vehicular steering control apparatus as claimed in claim 6, wherein the carrier frequency control section sets the carrier frequency at the non-audible frequency higher than the audible frequency when the steering speed is equal to or below the set steering speed.

According to the structure described above, the high output is not requested for the electric motor in a case where the steering speed is equal to or below the set steering speed and the high output is not required for electric motor. In this case, the carrier frequency is set to the non-audible frequency allowing the increase in the switching loss so that the noises of the inverter involved in the drive of the electric motor can be reduced.

This application is based on a prior Japanese Patent Application No. 2009-071555 filed in Japan on Mar. 24, 2009. The entire contents of this Japanese Patent Application No. 2009-071555 are hereby incorporated by reference. Although the invention has been described above by reference to certain embodiments of the invention, the invention is not limited to the embodiment described above. Modifications and variations of the embodiments described above will occur to those skilled in the art in light of the above teachings. The scope of the invention is defined with reference to the following claims.

What is claimed is:

1. A vehicular steering control apparatus, comprising:
a steering mechanism configured to steer steerable wheels of a vehicle according to a steering force;
an electric motor configured to be drivingly controlled to provide the steering force for the steering mechanism;
a steering quantity calculation section configured to calculate a manipulated variable of the electric motor;
a PWM control section configured to generate a PWM control signal to drive the electric motor on a basis of the manipulated variable of the electric motor;
an inverter configured to supply an electric power to the electric motor according to switching operations thereof based on the PWM control signal; and
a carrier frequency control section configured to control a carrier frequency of the PWM control signal,
wherein the carrier frequency control section is configured to set the carrier frequency to at least two predetermined set frequencies in accordance with at least one of a driving state of the electric motor and a traveling state of the vehicle, one of the predetermined set frequencies being set to reduce noises in the inverter and the other of the predetermined set frequencies being set to reduce a switching loss in the inverter.

2. The vehicular steering control apparatus as claimed in claim 1, wherein the carrier frequency control section is configured to set the carrier frequency in a case where the electric motor is driven in a rotational speed region higher than the rotational speed in a constant torque region in which the maximum torque is generable to be lower than the carrier frequency in a case where the electric motor is driven in the constant torque region.

3. The vehicular steering control apparatus as claimed in claim 2, wherein the vehicular steering control apparatus further comprises: a rotational speed determination section configured to determine the rotational speed of the electric motor and the carrier frequency control section is configured to set the carrier frequency on a basis of an output of the rotational speed determination section.

4. The vehicular steering control apparatus as claimed in claim 2, wherein the carrier frequency control section is configured to set a carrier frequency progressively reduction region in which the carrier frequency is progressively reduced along with an increase in the rotational speed of the electric motor in the rotational speed region in which the rotational speed of the electric motor is higher than that in the constant torque region.

5. The vehicular steering control apparatus as claimed in claim 2, wherein the carrier frequency control section is configured to set the carrier frequency to a predetermined first set frequency when the rotational speed of the electric motor is equal to or below a base speed in the constant torque region and to set the carrier frequency to a predetermined second set frequency region when the rotational speed of the electric motor is in excess of a predetermined set rotational speed in a further higher rotational speed region than the constant torque region, the predetermined first set frequency being set to be in a non-audible frequency higher than an audible frequency at which the predetermined second set frequency is set.

6. The vehicular steering control apparatus as claimed in claim 2, wherein the vehicular steering control apparatus further comprises an input current detection section configured to detect a primary current caused to flow into the inverter from a DC power supply and the carrier frequency control section is configured to set the carrier frequency to be a predetermined first set frequency when a the primary current is equal to or smaller than a predetermined first set current, to be a predetermined second set frequency when the primary current is in excess of a predetermined second set current, and to be progressively reduced along with an increase in the primary current when the primary current is in excess of the predetermined first set current and is equal to or smaller than the predetermined second set current, the predetermined second set frequency being lower than the predetermined first set frequency.

7. The vehicular steering control apparatus as claimed in claim 2, wherein the vehicular steering control apparatus further comprises an input voltage detection section configured to detect an input voltage to be supplied to the inverter and the carrier frequency control section is configured to set the carrier frequency to a predetermined second set frequency when the input voltage is equal to or lower than a predetermined first set voltage, to set the carrier frequency to a predetermined first set frequency when the input voltage is in excess of the predetermined second voltage, and to set the carrier frequency to be progressively reduced along with an decrease in the input voltage in a case where the input voltage is in excess of the predetermined first set voltage and is equal to or lower than the predetermined second set voltage.

8. The vehicular steering control apparatus as claimed in claim 2, wherein the steering quantity calculating section comprises a q-axis current deviation integration value calculation section configured to calculate a q-axis current deviation integration value of the electric motor and the carrier frequency control section is configured to set the carrier frequency on a basis of the q-axis current deviation integration value of the electric motor, the q-axis current deviation integration value being varied in accordance with the rotational speed of the electric motor.

9. The vehicular steering control apparatus as claimed in claim 2, wherein the steering quantity calculation section comprises: a d-axis target current calculation section configured to calculate a d-axis target current on a basis of the rotational speed of the electric motor and the carrier frequency control section sets the carrier frequency on a basis of the d-axis target current.

10. The vehicular steering control apparatus as claimed in claim 2, wherein the PWM control section comprises: a modulation rate calculation section configured to calculate a modulation rate which provides a basis for the generation of the PWM control signal in the PWM control section and the carrier frequency control section is configured to set the carrier frequency on a basis of the modulation rate, the modulation rate being varied in accordance with the rotational speed of the electric motor.

11. A vehicular steering control apparatus as claimed in claim 1, wherein the vehicular steering control apparatus further comprises: a vehicle speed sensor configured to detect a traveling speed of the vehicle and wherein the carrier frequency control section is configured to set the carrier frequency to a predetermined second set frequency when the traveling speed is equal to or lower than a predetermined first set traveling speed, to set the carrier frequency to a predetermined first set frequency when the traveling speed is in excess of the predetermined second set traveling speed, and to set the carrier frequency to be progressively reduced along with a decrease of traveling speed when the traveling speed of the traveling speed is in excess of the predetermined first set traveling speed and is equal to or below the predetermined second set traveling speed.

12. The vehicular steering control apparatus as claimed in claim 11, wherein the vehicular steering control apparatus further comprises a voltage detection section configured to detect an input voltage to be supplied to the inverter and wherein the carrier frequency control section is configured to set the carrier frequency to the predetermined first set frequency even if the input voltage is in excess of a predetermined second set voltage and the traveling speed of the vehicle is equal to or lower than the predetermined second set traveling speed and is configured to set the carrier frequency to the predetermined second set frequency when the traveling speed of the vehicle is equal to or lower than the first set traveling speed and the input voltage is equal to or lower than a predetermined first set voltage, the predetermined second set frequency being lower than the predetermined first set frequency.

13. The vehicular steering control apparatus as claimed in claim 1, wherein the vehicular steering control apparatus further comprises a steering speed determination section configured to determine a steering speed which is a rotational speed of the steering wheel on a basis of a steering angle of a steering angle sensor, the carrier frequency control section is configured to control the carrier frequency of the PWM control signal on a basis of the steering speed, and the carrier frequency control section is configured to set the carrier frequency to a predetermined first set frequency when the steering speed is equal to or below a predetermined first set steering speed, to set the carrier frequency when the steering speed is in excess of a predetermined second set steering speed, to set the carrier frequency to progressively be reduced along with the increase in the steering speed when the steering speed is in excess of the predetermined first set steering speed and is equal to or lower than the predetermined second set steering speed.

14. The vehicular steering control apparatus as claimed in claim 11, wherein the steering speed is calculated on the basis of the rotational speed of the electric motor.

15. The vehicular steering control apparatus as claimed in claim 13, wherein the steering speed determination section comprises a steering speed detection section including a steering angle sensor configured to detect a steering angle of a steering wheel of the vehicle and a steering speed calculation section configured to calculate the steering speed of the vehicle on a basis of the steering angle and wherein the vehicular steering control apparatus further comprises an input voltage detection section configured to detect an input voltage supplied to the inverter and wherein the carrier frequency control section is configured to maintain the carrier frequency at a predetermined first set frequency even if the steering speed is in excess of the predetermined first set steering speed and in a case where the input voltage is in excess of a predetermined second set voltage and is configured to set the carrier frequency to a predetermined second set frequency in a case where the input voltage is equal to or below a predetermined first set voltage and the steering speed is in excess of a predetermined second steering speed, and is configured to set the carrier frequency to progressively be reduced, in a case where the steering speed is in excess of first set steering speed, and the input voltage is in excess of the first set voltage and is equal to or below second set voltage.

16. The vehicular steering control apparatus as claimed in claim 11, wherein the steering speed detection section comprises a steering speed determination section including a steering angle sensor configured to detect a steering angle of a steering wheel of the vehicle and a steering speed calculation section configured to calculate the steering speed of the vehicle on a basis of the steering angle and wherein the vehicle steering control apparatus further includes a vehicle speed sensor configured to detect a traveling speed of the vehicle and wherein the carrier frequency control section is configured to maintain the carrier frequency at a predetermined first set frequency even when the traveling speed of the vehicle is equal to or lower than second set traveling speed in a case where steering speed is equal to or lower than first set steering speed, is configured to set the carrier frequency to second set frequency in a case where the traveling speed of the vehicle is equal to or lower than the predetermined first traveling speed and the steering speed is in excess of the second set steering speed, and is configured to progressively be lowered along with an increase in the steering speed in a case where traveling speed of the vehicle is equal to or lower than second set traveling speed and the steering speed is in excess of the predetermined first set steering speed and is equal to or lower than the predetermined second set steering speed.

17. A vehicular steering control method comprising:
providing a steering mechanism configured to steer steerable wheels of a vehicle according to a steering force;
providing an electric motor configured to be drivingly controlled to provide the steering force for the steering mechanism;
calculating a manipulated variable of the electric motor;
generating a PWM control signal to drive the electric motor on a basis of the manipulated variable of the electric motor;
providing an inverter for supplying an electric power to the electric motor according to switching operations thereof based on the PWM control signal; and
controlling a carrier frequency of the PWM control signal,
wherein, during the control of the carrier frequency, the carrier frequency is set to at least two predetermined set frequencies in accordance with at least one of a driving state of the electric motor and a traveling state of the vehicle, one of the predetermined set frequencies being set to reduce noises in the inverter and the other of the predetermined set frequencies being set to reduce a switching loss in the inverter.
